(19) United States
(12) Patent Application Publication
(10) Pub. No.: US 2007/0028115 A1
(43) Pub. Date: Feb. 1, 2007

(54) Method for guaranteeing the integrity and authenticity of flashware for control devices

(75) Inventors: Heiko Kober, Calw (DE); Jutta Schneider, Tuebingen (DE); Michael Sorg, Frechen (DE); Eva Wieser, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/553,599

(22) PCT Filed: Mar. 4, 2004
(86) PCT No.: PCT/EP04/02194

§ 371 Date: Jul. 6, 2006

(30) Foreign Application Priority Data
Apr. 19, 2003 (DE) 10318031.1

(51) Int. Cl. H04L 9/00

(52) U.S. Cl. 713/180

(57) ABSTRACT

The invention relates to a simplified symmetrical, cryptographic method. The basis of this method is an authentication code. This authentication code is calculated in a secured area, referred to as a trust center, by concatenating the application program, referred to as the flashware, with a secret data string and calculating a hash value from the concatenated application program. This hash value is calculated here by means of the application program and by means of the secret data string. This hash value is the authentication code for the application program to be checked. The authentication code is checked in the microprocessor system or in the control unit in which the application program is to be used. For this purpose, a second, identical, secret data string is stored in the microprocessor system or the control unit. Firstly, the unencrypted application program and the authentication code are transmitted into the micro-processor system or into the control unit. The unencrypted application program is then concatenated with the second, identical, secret data string in the microprocessor system or in the control unit. A hash value is calculated by this concatenated application program in the microprocessor system or in the control unit. If the calculated hash value and the transmitted authentication code correspond, the transmitted application program or the transmitted flashware is considered to be authentic and is allowed to be stored in the flash memory and applied in the control unit or in the microprocessor system. In a development of the invention, the application program is concatenated with the secret data string at both ends both at the start of the program and at the end of the program. The hash value is then calculated by means of the application program which is concatenated at both ends. In order to check the authentication code which is formed in this way, in the microprocessor system or in the control unit the application program which is transmitted in unencrypted form is also concatenated at both ends with the second, secret data string stored in the control unit, and a hash value is formed in the control unit or in the microprocessor system by means of the application program which is concatenated at both ends. If the hash value calculated in the control unit or in the microprocessor system corresponds to the transmitted authentication code, the transmitted application program is considered to be authentic. The concatenation at both ends has the advantage of improved protection against unacceptable manipulations of the application software.

### BACKGROUND AND SUMMARY OF THE INVENTION

This application claims the priority of German patent document 103 18 031.1, filed Apr. 19, 2003 (PCT International Application No. PCT/EP2004/002194, filed Mar. 4, 2004), the disclosure of which is expressly incorporated by reference herein.

The invention relates to a security system for downloading software into a control unit.

The increasing presence of electronics in motor vehicles, and the increasing possibilities for communicating in and with a vehicle, have entailed a corresponding increase in the demands upon security. Nowadays, microcontrollers are used for control purposes in various areas of technology, and are frequently connected to one another via a bus system that is externally accessible for communicating with the individual control units. The functionality of the control units is determined by application programs, which, in the past, have usually been stored in a nonprogrammable memory, preferably in the control unit. As a result, the software cannot be readily tampered with. For example, the complete replacement of a memory module with another memory module can be detected and dealt with.

However, the future use of programmable control units, in particular what are referred to as flash-programmable control units, in vehicles increases the risk of unauthorized manipulations to the application programs and thus to the operation of the control units. For this reason it is necessary to take measures which prevent unauthorized overwriting of application programs in the control units.

A typical downloading process for an application program, referred to as flashware, is disclosed in German patent document DE 195 06 957 C2. In this system, such an application program is stored in a nonvolatile electrically erasable and programmable memory (referred to in the specialist field as a flash EPROM memory, or for short as a “flash”). An initialization routine stored in the boot area in the flash is used to load and start the user programs when the microprocessor system is put into operation.

In order to be able to replace an existing application program with a new one, the initialization routine additionally contains what is referred to as a reloading routine, which is activated by a special instruction via a system interface. After activation, the reloading routine first stores the new application program in a buffer. A cyclic block protection method is used to check whether the storing of the new application program was faulty. If it was transmitted and buffered correctly, the erasure of the user program which is to be replaced is initiated and carried out. For this purpose, the new application program is overwritten over the old application program in the erasable and programmable read-write memory (flash).

This process of programming and copying into the flash can also be checked by means of a cyclic block protection method, which however, makes it possible only to check the extent to which the program has been copied correctly. Checking for data integrity and authenticity is not possible with cyclic block protection methods. An unauthorized program or unauthorized flashware cannot be detected with cyclic block protection methods.

On the other hand, encryption methods and digital signature methods are known from the field of the Internet, in particular for home banking and home-shopping applications. The basis for all the encryption methods that are widespread today is what is referred to as public key encryption. Such encryption algorithms operate with a secret key and a public key; the latter may be known publicly, while the secret key may be known only to an authorized party, for example a trust center. Such cryptographic algorithms are, for example, Rivest, Shamir and Adelman (RSA algorithm) data encryption algorithm (DEA algorithm) or the like. With the secret or public key it is possible, in a fashion which is analogous to a handwritten signature, to produce a digital signature for an electronic document. Only the user of the secret or public key can produce a valid signature. The genuineness of the document can then be checked by verifying the signature using the associated public or secret key. The secret key is sometimes also referred to as a private key.

The electronic signature has become known as a signature method. The purpose of the electronic signature is to ensure that a message reliably comes from a certain sender, and that it has not been falsified during the transmission.

Once the sender has generated a public key and a private key, the following method is conceivable:

The sender of the information uses his own private key to encrypt a message which can be read with the public key of the sender. A message which can be read with the public key can only originate from the sender because only the sender has the matching private key. The system is such that the private key can be used only for encryption while the public key can be used only for decryption or reading. Therefore, messages are produced which can be written by only one person, but can be read by all persons having the public key.

The encryption of the entire message using the abovementioned encryption methods is relatively intensive in terms of computing time, and it is unnecessary for the purpose of defining only the authenticity of the author. For this reason, a somewhat different method is used in practice:

The sender calculates a type of summary or checksum of the message, referred to as the hash code. The calculation rule here is such that it is virtually impossible to change the message without simultaneously changing the hash code.

The sender then encrypts the hash code with his private key. This is the electronic signature. The signature is therefore different for each message, only the length of the signature is always the same, irrespective of the length of the message (a property of the hash codes).

The message is then sent with the signature.

The receiver decrypts the signature with the public key of the sender and then receives the hash code acquired from the sender.

The receiver himself can then determine the hash code of the original message and compare it with the hash code which has also been sent by the sender. If both hash codes correspond, it is ensured that the message actually originates from the one sender and that it has not been falsified on the transmission path.

The abovementioned signature method for deciphering is based on the public key method RSA, and for the calculation of the hash code on the hash function RIPEMD-160.

Finally, by combining encryption and an electronic signature it is possible to send messages which can be reliably and unambiguously assigned to a sender before falsification.

German patent document DE 100 08 974 A1 discloses a signature method for ensuring the data integrity of software for a control unit in a motor vehicle based on the abovementioned encryption and signature method. In this method, the public key is stored in a memory area of the control unit, and the software which is to be fed in (referred to as the flashware) is signed with a second secret key. In order to feed in the signed software, this flashware is first stored in a memory on the control unit. The signature of the flashware is checked with the public key stored in the control unit itself. If the checking of the electronic signature has a positive result, the buffered flashware is read into an electronically erasable and programmable memory on the control unit, referred to as the flash.

Not all control units are capable of calculating the public key algorithms since some of them cannot support sliding decimal point arithmetic or make available sufficient memory space. In order to be able to form RSAs reliably, at present at least 1024 byte should be selected as the key length. It is therefore impossible to use the abovementioned signature methods in many of the control units which are currently used in motor vehicles.

Taking the abovementioned prior art as a point of departure, one object of the invention is to provide a simplified signature method which can be used on as nearly as possible all control units in contemporary motor vehicles.

This and other objects and advantages are achieved by the simplified symmetrical, cryptographic method according to the invention, which is based on an authentication code that is calculated in a secured area (referred to as a trust center) by concatenating the application program, (referred to as the flashware) with a secret data string and calculating a hash value from the concatenated application program. The hash value, which is calculated by the application program and using the secret data string, is the authentication code for the application program to be checked.

The authentication code is checked in the microprocessor system or in the control unit in which the application program is to be used. For this purpose, a second, identical, secret data string is stored in the microprocessor system or the control unit. First, the unencrypted application program and the authentication code are transmitted into the microprocessor system or into the control unit. The unencrypted application program is then concatenated with the second, identical, secret data string in the microprocessor system or in the control unit. A hash value is calculated by this concatenated application program in the microprocessor system or in the control unit. If the calculated hash value and the transmitted authentication code correspond, the transmitted application program or the transmitted flashware is considered to be authentic and is allowed to be stored in the flash memory and applied in the control unit or in the microprocessor system.

In one embodiment of the invention, the application program is concatenated with the secret data string at both ends, both at the start of the program and at the end of the program. The hash value is then calculated by means of the application program which is concatenated at both ends. In order to check the authentication code which is formed in this way, in the microprocessor system or in the control unit the application program which is transmitted in unencrypted form is also concatenated at both ends with the second, secret data string stored in the control unit, and a hash value is formed in the control unit or in the microprocessor system by means of the application program which is concatenated at both ends. If the hash value calculated in the control unit or in the microprocessor system corresponds to the transmitted authentication code, the transmitted application program is considered to be authentic. The concatenation at both ends has the advantage of improved protection against unacceptable manipulations of the application software.

A further improvement with respect to manipulations is obtained by calculating a hash value twice. In this embodiment of the invention, the application program is first concatenated at one end with a secret data string, and a hash value is then calculated by the application program which is concatenated at one end. The concatenation can be at the start of the program or at the end of the program here. This first hash value HMAC1 is in turn concatenated with this secret data string at one end. The concatenation may be carried out here at each end of the first hash value. Finally, in order to calculate an authentication code a second hash value HMAC is then calculated using the combination of the data string and first hash value HMAC1, in a further step.

In order to check the authentication code in the control unit or in the microprocessor system, the abovementioned calculation steps must be repeated in the same sequence in the microprocessor system or in the control unit. If the calculated hash value corresponds to the transmitted authentication code, the transmitted application software is therefore considered to be error free.

For the process of downloading the flashware itself there are various transmission possibilities. The flashware and authentication code may be transmitted together on the same distribution channel; or alternatively the authentication code may be transmitted on separate distribution channels by means of the application program. With separate transmission it is advantageous to market the flashware or the application program on hardware storage media. Compact discs, EPROMs or memory cards are possible as preferred storage media.

When the application program which is to be transmitted into the flash memory of the system is successfully authenticated, it is preferably provided with an identifier, referred to as a flag, which identifies it as valid.

The invention mainly achieves the following advantages:

Not all control units are capable of calculating the public key algorithms since some of them cannot support sliding decimal point arithmetic, or cannot make available sufficient memory space to carry out the necessary encryption calculations. In order to form the public key algorithms reliably, at present at least 1024 byte should be selected as the key length. Since many control units in motor vehicles only have a memory area of only 4 kbyte, the key alone would take up a large part of the memory.

The invention also does not require encryption algorithms. The single calculation method which is used is to calculate hash values. By using the symmetrical, cryptographic method according to the invention it is also possible to equip these control units with an authentication check for which public key methods cannot be applied.

The method according to the invention is what is referred to as a message authentication code method which is based on the calculation of a hash value. There is therefore no signature method, such as requires the receiver of a message to be incapable of copying the signature which is also supplied. For application in embedded systems (for example, control units), a signature method is not necessary since the receiving control unit does not automatically form the message authentication code for a message. The control unit merely checks a given, secret data string for a given message. It is necessary to calculate a hash value in order to secure the transmission path. According to the invention, only the hash value of a message authentication code is in fact transmitted, and not the secret data string. The proposed hash value method according to the invention is significantly more efficient in terms of running time and memory space than enciphering and deciphering methods such as, for example, the public key algorithms, can be.

Flashware meta information (for example, the storage location of a flashware, the identification number of the flashware, the identification number of the control unit or the vehicle identification number) can also be included in the authentication code. Since this flashware meta information is integrated into the secret data string, the formation of a hash value by means of the flashware and the secret data string thus ensures that the flashware meta information is also protected against manipulations on the transmission path.

If the same flashware is used on a plurality of control units, including the flashware meta information in the authentication code makes it possible to select the downloading process for flashware into the various control units using this authentication code. Since various control units have various identification numbers, and the storage locations for the flashware in the various control units are different, even when the flashware is the same there is a control unit-specific authentication code in each case according to the inventive method.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic diagram of a process for downloading flashware from a data memory to the control unit of a motor vehicle;

FIG. 2 is a schematic diagram of a process for downloading flashware in which the flashware and the authentication code enter the control unit of a motor vehicle on separate distribution channels;

FIG. 3 is a flowchart showing the calculation of an authentication code for the downloading process according to FIG. 1;

FIG. 4 is a more detailed flowchart showing the calculation of an authentication code for the downloading process according to FIG. 1;

FIG. 5 is a flowchart showing the calculation of an authentication code for the downloading process according to FIG. 2;

FIG. 6 is a more detailed flowchart showing the calculation of an authentication code for the downloading process according to FIG. 2; and

FIG. 7 is a block diagram of a microprocessor system or of a control unit having a flash memory into which an application program can be downloaded with the method according to the invention.

### DETAILED DESCRIPTION OF THE DRAWINGS

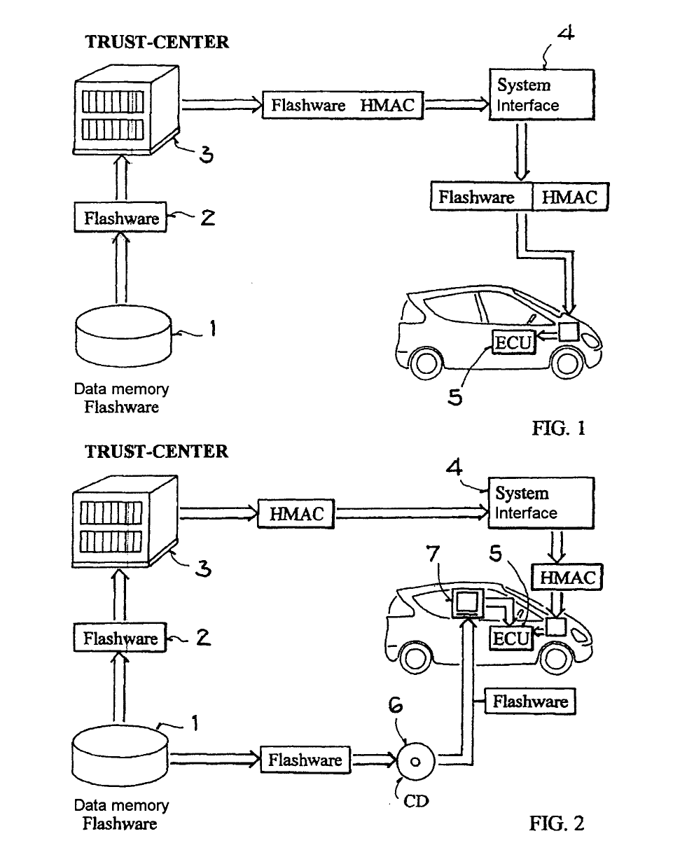

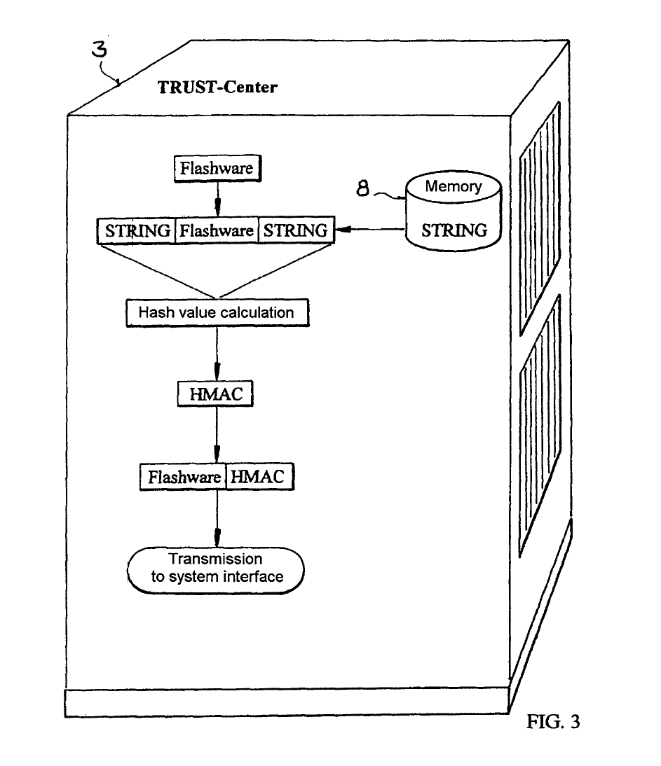

FIG. 1 shows a possible downloading process in which the invention is used. After the program development has been concluded, the application programs and/or the flashware are collected in a data memory 1. The individual application programs or application RAM packets 2 are transferred on a secured path to what is referred to as a trust center 3, where they are identified with an authentication code. (The sequences in the trust center itself are explained in more detail below in conjunction with FIGS. 3 to 6.) The unencrypted flashware, together with the authentication code HMAC is transferred from the trust center to an external system interface 4, which, in the simplest case, may be a diagnostic connection in the motor vehicle. (However, the system interface is generally formed by the diagnostic system in motor vehicle workshops.)

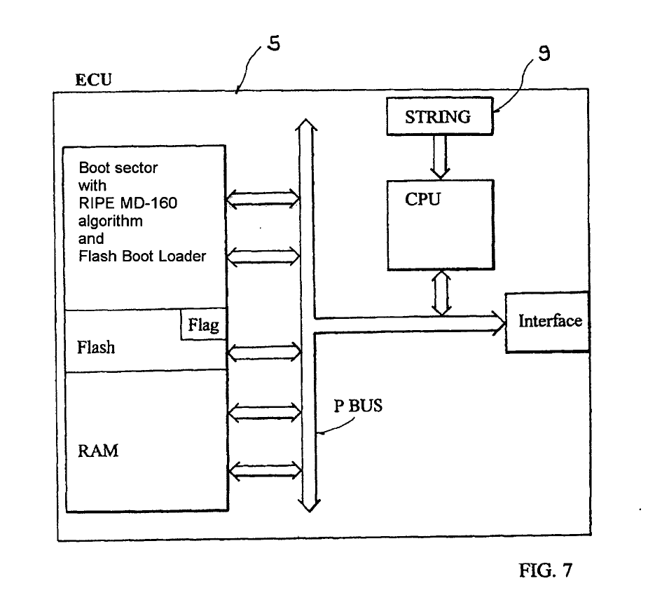

For transmitting from the trust center to the system interface it is possible to use the customary data communication paths; that is, in particular fixed network connections, Internet connections and also mobile radio connections. The system interface brings about the process of downloading the transmitted program package or the transmitted flashware and the authentication code HMAC into a control unit of a motor vehicle. For this purpose, it transmits to the control unit in the motor vehicle a special command, with which the flashware memory in the motor vehicle is prepared for the downloading process. (The programming of the new application program into the flash memory is explained in more detail below in conjunction with FIG. 7.)

The transmitted authentication code HMAC is checked in the control unit of the motor vehicle and when successful checking occurs the flashware which is also transmitted is programmed into the flash memory of the control unit. The checking of the authentication code in the control unit of the motor vehicle is essentially carried out by repeating the steps with which the authentication code in the trust center was generated. (More details on the checking of the authentication code can be found below in the figure descriptions relating to FIGS. 3 to 6.)

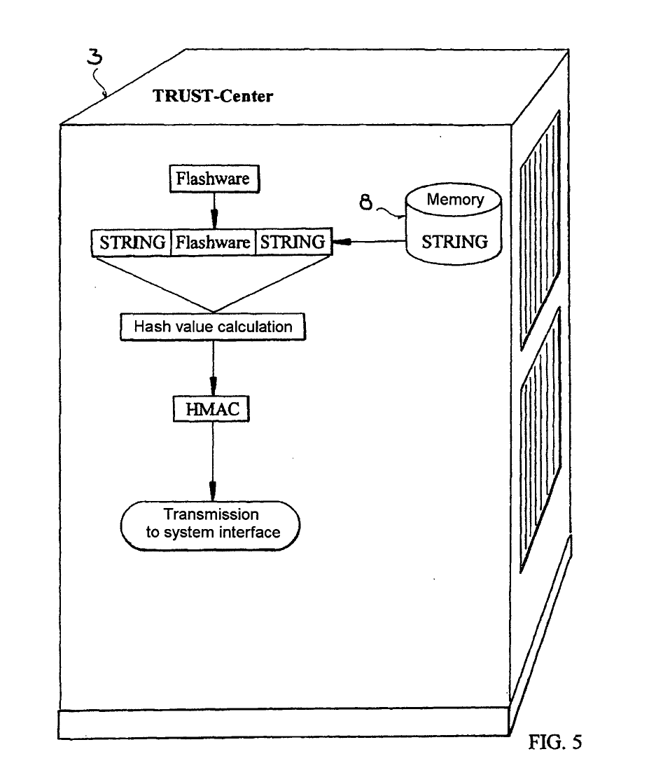

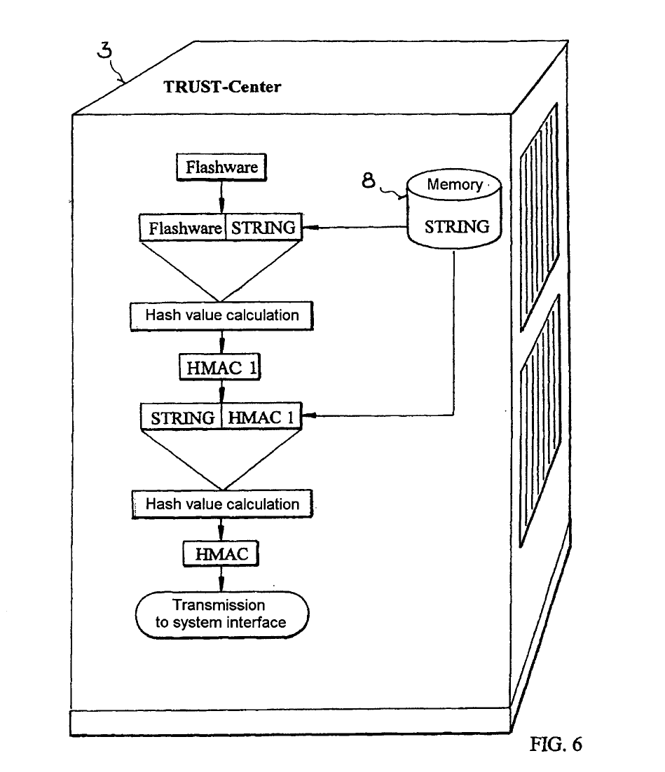

FIG. 2 shows another embodiment of the downloading process according to the invention, in which the application programs (“flashware”) are also collected in a data memory 1, and then transferred as program packages 2 to a trust center. An authentication code is generated for the flashware in the trust center 3, using a calculation that is explained in more detail in conjunction with FIGS. 5 and 6.) In contrast to the downloading process according to FIG. 1, with the downloading process described here only an authentication code HMAC is transmitted from the trust center to the system interface 4. The application program itself (the so-called flashware) is transferred on a separate distribution channel.

The flashware is preferably recorded on compact discs, storage cards, EPROMs or other hardware storage means 6 and transmitted into the control unit 5 of the motor vehicle using a suitable reading device 7. In particular in the case of compact discs, the suitable reading device 7 in the motor vehicle may be an infotainment system such as is used today in motor vehicles (for example, a CD-ROM disk drive or a DVD disk drive).

In the exemplary embodiment according to FIG. 2 the downloading process is also initiated in the vehicle by means of a special command from the system interface 4, which for this purpose has access to the data buses of the onboard power system in the motor vehicle. The reading in of the flashware from the reading device 7 into the control unit 5 is started by the system interface using a software command. At the same time, the software command is used to prepare the flash memory of the control unit 5 for the transfer of the flashware.

The checking of the authentication code HMAC in a control unit will be explained in more detail below in the figure descriptions relating to FIGS. 5 and 6. In principle, in order to check the authentication code, the calculation steps which were necessary to produce the authentication code must be repeated in the control unit in the same order as in the trust center.

In this exemplary embodiment, the system interface can also be formed in the simplest case by diagnostic connection in the motor vehicle. However, the system interface is preferably the diagnostic system in the motor vehicle workshop. Moreover, the previously described checking of the authentication code applies irrespective of the selection of the transmission path for the flashware. The authentication sequence is the same when downloading the flashware from CD-ROM or DVD as when directly downloading the flashware from the central system by means of wirefree or wirebound data transmission.

All the exemplary embodiments of the invention have in common the calculation of a hash value. The hash function, known by the designation RIPEMD-160 algorithm, can be used to generate a check value, also called copy, of fixed length for data of any desired length. This copy is referred to as a hash value. A hash function and a hash value have the following properties:

The hash value is easy to calculate.

It is virtually impossible to generate, for a given hash value, a data record which supplies this hash value (oneway function). In addition it is difficult to find a collision, i.e., two data records with the same hash value (collision resistance).

The hash function can be applied only for data or data records whose bit length is 2⁶⁴−1 at maximum. In the case of relatively short data records, the data records are filled with zeros until the length of the filled-in data record has an integral multiple of 512 bit. The filled-in data record is then divided into at least 512 bit long blocks. Applying the hash function to the 512 bit long blocks finally results in a 160 bit long hash value. The function can be applied here to any desired data records, in particular also to flashware.

FIG. 3 shows a flowchart for calculating an authentication code within a secured area 3, referred to below as a trust center. In the trust center, secret identifiers in the form of data strings are managed in digital form in a separate, secured area, preferably a separate, secured data memory 8. The flashware for which an authentication code is to be calculated is firstly concatenated with a data string at both ends of the application program. That is, a secret data string from the memory 8 of the trust center is appended to the digital data record of the application program at the start and at the end. In the next step, a hash value is calculated for the flashware which is concatenated at both ends. This hash value contains all the information about the flashware and about the secret data string. Due to the previously explained properties of the hash function, this hash value is suitable as an authentication code HMAC for the authenticity and the data integrity of the flashware. In the next step, the authentication code HMAC is added to the unencrypted application program, the so-called flashware, and transferred from the trust center to the system interface for further transmission into the motor vehicle.

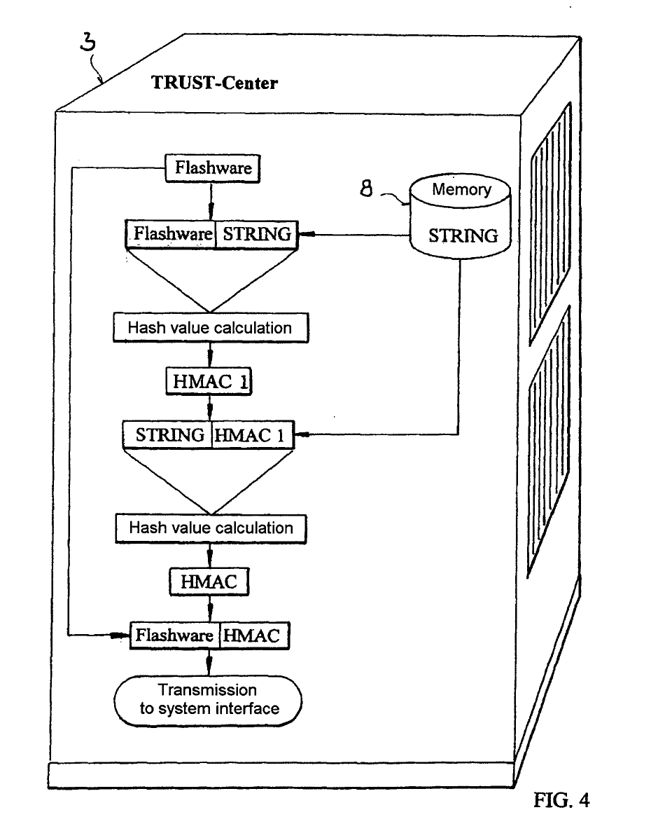

FIG. 4 shows a more complicated sequence for calculating an authentication code in a trust center. In this embodiment, the flashware is first concatenated at one end with a secret data string, either at the start or at the end of the data record of the flashware. A first hash value calculation can be carried out using the flashware which is concatenated at one end, generating a first hash value HMAC1. This first hash value HMAC1 is in turn, concatenated at one end with a secret data string from the memory 8, once again at the start or at the end of the first hash value. In a further step, a second hash value calculation is carried out by means of the combination of the secret data string and first hash value. The result of this last hash value calculation provides the authentication code HMAC. Unencrypted original flashware is then added to the authentication code and transmitted to the system interface. The exemplary embodiment in FIG. 4 is suitable for a downloading process according to FIG. 1.

FIG. 5 is a flowchart showing the calculation of an authentication code within a trust center for use in the downloading process according to FIG. 2. In the trust center, the unencrypted original flashware is concatenated at both ends with a secret data strength. In the next step, a hash value calculation is carried out for the flashware which is concatenated at both ends, thereby generating the authentication code HMAC.

In contrast to the exemplary embodiment in FIG. 3, in the exemplary embodiment in FIG. 5 only the authentication code is transmitted to the system interface. The marketing of the original and unencrypted flashware is carried out here on separate distribution channels. The flashware is preferably transferred here to hardware storage elements and read into the motor vehicle (see FIG. 2 for more details on this).

FIG. 6 shows a further embodiment of a more complex calculation of an authentication code such as is used in conjunction with downloading processes according to FIG. 2. In this embodiment, the unencrypted flashware is first concatenated at one end with a secret data string in the trust center, either at the start or at the end of the data record of the flashware. A hash value calculation is carried out by means of the flashware which is concatenated at one end, generating a first hash value HMAC1. This first hash value HMAC1 is in turn concatenated at one end with a secret data string from the memory 8. Here too, the concatenation can be carried out at the start or at the end of the first hash value. In a further step, a second hash value calculation is carried out by means of the combination of a secret data string and first hash value. The result of this last hash value calculation provides the authentication code HMAC, which is transferred to the system interface. In contrast to the exemplary embodiment in FIG. 4, in the exemplary embodiment in FIG. 6 only the authentication code is transferred to the system interface. Here, analogous to FIG. 2, the unencrypted original software is read into the motor vehicle by means of storage media, preferably compact discs.

More details will be given below on the flash process in the control unit or in the microprocessor system of the motor vehicle with reference to FIG. 7. A typical control unit, also referred to as electronic control unit ECU, contains a computing unit (a microprocessor CPU), which is connected via a processor bus PBUS to various memories or memory sectors. Via an interface, the control unit can either be addressed from the outside or can communicate with other units connected to the interface. The memory of the control unit is composed of a boot sector, a flash memory, and a main memory RAM. The flash memory Flash is an electrically erasable and programmable memory, for example an EEPROM. The operating system of the microprocessor, referred to as a flash boot loader, and the RIPEMD-160 algorithm for the hash function are stored in the boot sector.

A secret data string is stored in the control unit in a memory or memory area 9 which is specially protected against external access, and may be arranged in the boot area, or provided in the form of a memory card which cannot be overwritten and is protected against unauthorized reading out, or in the form of what is referred to as a cryptoprocessor which erases its contents when unauthorized access is attempted. These measures and the embodiment of the specially protected memory area 9 ensure that the data string stored therein is kept secret. Which data strings are programmed in the specially protected data area 9 must be coordinated with the data strings for calculating the authentication codes in the trust center. The data string in the control unit must correspond to the data string which was used as the basis for calculating the authentication code.

The application programs which can be used as flashware are stored in the flash of the control unit. User programs which have already been stored are overwritten with new flashware basically in the following way. The control unit is prepared for a downloading process and for a flash process by a special software command which is transmitted from an external system interface via the interface of the control unit. What is referred to as the flash boot loader is actuated by means of the software command. The flash boot loader is essentially a reloading routine with which application programs are written into the flash memory of the control unit. During the downloading process, the new flashware and the transmitted authentication code are first buffered in the main memory of the control unit. The buffered flashware and the buffered authentication code are then checked for authenticity and data integrity in the microprocessor of the control unit, using the reloading routine of the flash boot loader. This checking is carried out in such a way that the same method steps which were applied to generate the transmitted authentication code are carried out in the microprocessor with the unencrypted software and the secret data string which is stored in the control unit. Those method steps which are carried out in the trust center in order to generate the authentication code are therefore repeated in the microprocessor of the control unit. If, for example, the authentication code was generated according to the exemplary embodiment in FIG. 3, in the microprocessor of the control unit the buffered flashware is concatenated at both ends with the secret data string stored in the control unit. The flashware which is concatenated at both ends carries out a hash value calculation using the RIPEMD-160 algorithm. The result of this hash value calculation in the control unit is compared with the transmitted identification code HMAC. If both hash values are identical, the flashware buffered in the main memory is considered to be authentic and integral. If the authentication code in the trust center was acquired according to one of the exemplary embodiments corresponding to FIGS. 3, 4, 5 or 6, the concatenations of the buffered flashware with the secret data string stored in the control unit and the hash value calculations of the concatenated flashware for checking in the control unit or in the microprocessor of the control unit must be carried out in the way in which they were respectively carried out in the trust center in order to generate the transferred authentication code. A comparison of the hash value acquired by the microprocessor of the control unit with the transferred authentication code yields, if the two values correspond, in each case definitive information about the data integrity and authenticity of the transmitted flashware which has been buffered in the main memory. If both value correspond, the flashware is considered to be error free.

After successful checking of the newly downloaded and buffered flashware, the flash boot loader writes the new buffered flashware into the flash memory of the control unit. The copying process from the main memory into the flash memory can additionally be checked here for completeness with a cyclic block protection method. If the authenticity checking and the copying process were error free, a flag is set for the flashware located in the flash, which identifies the application program now located in the flash as the application program to be used as valid. As illustrated by way of example in FIG. 7, the flag can, for example be set here in the flash memory itself; the flash memory is preferably embodied as an EEPROM. The control unit can then enter the application and in the process will use the application programs identified with a valid flag.

The flash boot loader is preferably actuated by the diagnostic system in a workshop. In this case, the diagnostic system of the workshop forms the system interface 4. In the case of the downloading process according to FIG. 1, unencrypted flashware and authentication code are buffered together into the main memory of the control unit by the system interface via the interface. In the case of the downloading process according to FIG. 2, the authentication code is buffered into the main memory of the control unit via the system interface, while the unencrypted flashware is buffered into the main memory of the control unit via a further reading device, preferably a CD-ROM disk drive or a chip card reading device. In the case of the downloading process according to FIG. 2, the reloading routine of the flash boot loader must therefore, if appropriate, download the required data records from different electronic data processing systems. However, in all cases, communication in the vehicle takes place via the motor vehicle-internal data buses. A data bus which is widespread nowadays in motor vehicles is referred to as a CAN bus.

Not all control units in a motor vehicle have sufficient memory space to be able to buffer the flashware. For control units in which the existing memory area is not sufficient to buffer the downloaded flashware, the downloading process is carried out as follows:

Firstly the existing flash memory is erased.

The new flashware is then downloaded and programmed.

The downloaded flashware is then verified, that is to say checked for transmission errors.

The authentication checking is then carried out as in the preceding exemplary embodiments.

After positive authenticity checking, the downloaded flashware is identified and actuated by setting a flag in the form of a status bit.

the following applications then access the new flashware.

Directly downloading without buffering the flashware has the additional advantage of “end-to-end” protection since write errors are also detected in the writing process during the downloading process.

In all the exemplary embodiments of the invention, the flashware can have what is referred to as meta information added to it. This flashware meta information is, in particular, a vehicle identification number, a control unit parts number or a special memory location for the flashware. By including the flashware meta information it is possible, for example, to select the storage location for the flashware which is to be newly downloaded. Since the flashware meta information is also included in the calculation of the authentication code, this flashware meta information is also protected against manipulations.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-22. (canceled)

23. A method for loading an application program into a program memory of a microprocessor system having a processor bus that is connected to at least one microprocessor; at least one program memory with a boot sector, a flash boot loader, an electrically erasable and programmable memory and a read-write memory; and at least one system interface; said method comprising:
producing an authentication code for the application program;
reading in the authentication code and the current application program, via the system interface; and
before a read-in current application program is actuated, checking the authentication code; wherein,
the authentication code is calculated in a secured area by concatenating the application program with a first secret data string and calculating a hash value from the concatenated application program;
the hash value is read into the microprocessor system, via the system interface, as an authentication code;
a second, identical, secret data string is stored in the microprocessor system;
the read-in application program is concatenated with the second secret data string in the microprocessor system; and
a hash value is calculated by the read-in, concatenated application program in the microprocessor and is compared with the transmitted authentication code.

24. The method as claimed in claim 23, wherein:
the application program is concatenated with the first secret data string in the microprocessor at the start of the program and at the end of the program, both in the secured area and during the authenticity checking;
a hash value is calculated using the application program which is concatenated at both ends; and
the hash value is read in as an authentication code at the system interface.

25. The method as claimed in claim 23, wherein:
the application program is initially concatenated with the first secret data string either at the start of the program or at the end of the program;
in a following step, a first hash value is calculated in the secured area by using the application program which is concatenated at one end;
in a subsequent step, the first hash value is concatenated with a first secret data string at one end;
in a still further step, a second hash value is calculated by the combination of a first hash value and the first secret data string, and said second hash value is read in as an authentication code at the system interface;
a second, identical, secret data string is stored in the microprocessor system and the steps carried out in the secured area are repeated with the original application program in the same sequence using said second secret data string in the microprocessor; and
the hash value which is calculated in the microprocessor is compared with the hash value which is read in at the system interface.

26. The method as claimed in claim 25, wherein the authentication code is transferred together with the application program.

27. The method as claimed in claim 25, wherein the authentication code is transferred separately from the application program.

28. The method as claimed in claim 27, wherein:
the application program is stored and distributed in a memory medium; and
the authentication code is transmitted to the system interface from the secured area by means of data transmission.

29. The method as claimed in claim 26, wherein the application program and the authentication code are transmitted to the system interface from the secured area by data transmission.

30. The method as claimed in claim 29, wherein the authentication code is read into a control unit of a motor vehicle via the diagnostic interface.

31. The method as claimed in claim 30, wherein if a read-in authentication code and a hash value calculated in the microprocessor correspond, the associated application program is provided with an identifier as a valid application program.

32. The method as claimed in claim 31, wherein flashware meta information is included in the authentication code.

33. The method as claimed in claim 32, wherein the authentication code is used to selectively download the application program into various control units.

34. A method for safeguarding authenticity of flashware for a control unit of a motor vehicle in which an application program is stored in a program memory; said method comprising:
in a secured area, concatenating the application program with a first secret data string, and calculating a hash value using the concatenated application program;
reading the hash value into the control unit as an authentication code;
storing a second, identical, secret data string in the control unit;
concatenating application program with the second secret data string in the control unit;
calculating a second hash value using the concatenated application program in the control unit; and
comparing the calculated second hash value with the transmitted authentication code.

35. The method as claimed in claim 34, wherein:
the application program is concatenated with the first secret data string in the control unit at the start of the program and at the end of the program, both in the secured area and during the authentication checking;
a hash value is calculated using the application program which is concatenated at both ends; and
the hash value is read in as an authentication code at the system interface.

36. The method as claimed in claim 34, wherein:
the application program is initially concatenated with the first secret data string either at the start of the program or at the end of the program;
in a following step, a first hash value is calculated in the secured area using the application program which is concatenated at one end;
in a subsequent step, the first hash value is concatenated with a first secret data string at one end;
in a still further step, a second hash value is calculated by the combination of a first hash value and the first secret data string, and said second hash value is read in as an authentication code at the system interface;
a second, identical, secret data string is stored in the control unit and the steps carried out in the secured area are repeated with the original application program in the same sequence using said data string in the control unit; and
the hash value which is calculated in the control unit is compared with the hash value which is read in at the system interface.

37. The method as claimed in claims 36, wherein the authentication code is transferred together with the application program.

38. The method as claimed in claim 36, wherein the authentication code is transferred separately from the application program.

39. The method as claimed in claim 38, wherein the application program is stored and distributed in a memory medium; and
the authentication code is transmitted to the system interface from the secured area by means of data transmission.

40. The method as claimed in claim 37, wherein the application program and the authentication code are transmitted to the system interface from the secured area by means of data transmission.

41. The method as claimed in claim 40, wherein the authentication code is read into a control unit of a motor vehicle via the diagnostic interface.

42. The method as claimed in claim 41, wherein if a read-in authentication code and a hash value calculated in the control unit correspond, the associated application program is provided with an identifier as a valid application program.

43. The method as claimed in claim 42, wherein flashware meta information is included in the authentication code.

44. The method as claimed in claim 43, wherein the authentication code is used to selectively download the application program into various control units.
